(19) United States
(12) Patent Application Publication
(10) Pub. No.: US 2007/0194606 A1
(43) Pub. Date: Aug. 23, 2007

(54) VEHICLE ROOF PANEL HAVING SURFACE SIMULATIVE OF CLOTH

(76) Inventor: Gary Yeomans, Metamora, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/677,201

(22) Filed: Feb. 21, 2007

Related U.S. Application Data
(60) Provisional application No. 60/775,217, filed on Feb. 21, 2006.

(51) Int. Cl. B62D 25/06

(52) U.S. Cl. 296/210

(57) ABSTRACT

A vehicle body component is provided that includes a fiber reinforced cured material panel having an interior facing surface relative to a vehicle passenger compartment. The interior surface has a texture simulative of cloth without the actual application of a cloth layer to the interior facing surface. A texture simulative of a cloth layer is provided by fine protuberances extending from the interior facing surface to a height of between 35 and 1000 microns. A method of forming a vehicle roof panel is provided that includes laying a fiber reinforcement mat onto a first mold platen. The mold platen has a cavity shaped to form to the outside of the panel. A predetermined quantity of thermoset curable resin is poured over the fiber reinforcement mat, and the resin and mat are sealed within the mold cavity defined by the first mold platen and a second mold platen having interspersed crevices defining dimensions and spacing of multiple protuberances for shaping an interior facing surface of the panel relative to a vehicle passenger compartment. Through the application of heat and pressure for a sufficient amount of time, the thermoset resin cures to encapsulate the fiber reinforcement mat and penetrate the crevices to yield a panel with the interior facing surface having a texture simulative of cloth.

### CROSS-REFERENCE TO RELATED APPLICATIONS

This application claims priority of U.S. Provisional Patent Application Ser. No. 60/775,217 filed Feb. 21, 2006, which is incorporated herein by reference.

### FIELD OF THE INVENTION

The present invention in general relates to vehicle roof interior components and in particular to a molded vehicle roof component having a surface that simulates the appearance and texture of cloth.

### BACKGROUND OF THE INVENTION

The production of vehicle roof components and in particular sunshades requires a panel of considerable durability. The conventional process for forming a sunshade panel includes filling a mold cavity with a thermoset precursor and closing a mold platen to subject the resin precursor to sufficient heat and pressure so as to induce cure. Typical of these resins are those that form urethane linkages. A cloth facing sheet intended to project downward from the panel into a passenger compartment is inserted backing side up into a mold cavity and bonded to the panel through resin cure. Misalignment or creasing of the cloth during molding leads to quality control rejection of the panel.

Alternatively, after a panel has been molded, cloth is adhesively applied to the downward projecting surface and the panel trimmed to measurement specifications. Securement of the cloth to the molded article represents a time-consuming process that is prone to wastage and imparts additional material usage and cost associated with the cloth. Humidity, adhesive tack and handling all contribute to cloth delamination and wrinkling. While a cloth facing serves to limit glare off the inward facing panel surface to provide a measure of gripability, these improvements come at the cost of production inefficiency.

Thus, there exists a need for a vehicle roof panel such as a sunshade panel having an inward facing surface simulative of cloth absent the application of a cloth layer to the surface.

### SUMMARY OF THE INVENTION

A vehicle body component is provided that includes a fiber reinforced cured material panel having an interior facing surface relative to a vehicle passenger compartment. The interior surface has a texture simulative of cloth without the actual application of a cloth layer to the interior facing surface. A texture simulative of a cloth layer is provided by fine protuberances extending from the interior facing a surface to a height of between 35 and 1000 microns.

A method of forming a vehicle roof panel is provided that includes laying a fiber reinforcement mat onto a first mold platen. The mold platen has a cavity shaped to form to the outside of the panel. A predetermined quantity of thermoset curable resin is poured over the fiber reinforcement mat, and the resin and mat are sealed within the mold cavity defined by the first mold platen and a second mold platen having interspersed crevices defining dimensions and spacing of multiple protuberances for shaping an interior facing surface of the panel relative to a vehicle passenger compartment. Through the application of heat and pressure for a sufficient amount of time, the thermoset resin cures to encapsulate the fiber reinforcement mat and penetrate the crevices to yield a panel with the interior facing surface having, a texture simulative of cloth,

### BRIEF DESCRIPTION OF THE DRAWINGS

FIG. 1 depicts various surface protrusions that as a pattern are simulative of cloth.

### DETAILED DESCRIPTION OF THE PREFERRED EMBODIMENTS

The present invention has utility as a vehicle roof component simulative of a cloth surface without the need to actually apply a cloth layer. A process for the production of such a panel is also provided. According to the present invention, the time consuming and costly step of laminating a fabric to a molded roof panel is eliminated. Rather, the process of the present invention involves laying a fiber reinforcement sheet onto a mold platen and pouring a predetermined quantity of thermoset curable resin therein. The mold cavity is sealed for a duration at a pressure and temperature sufficient to induce resin cure. It is appreciated that the process steps of fiber reinforcement insertion and pouring resin are readily reversed. In the inventive process one or both mold platens are contoured such that the cured roof panel has at least one surface with a texture simulative of cloth.

A contoured mold platen is formed by a process illustratively including etching, such as chemical etch and plasma etch; machining; and embossing. Typically, the mold platen complementary to a panel with a surface simulative of cloth is roughened to have a mean depth differential between plateau and crevice features of between 35 and 400 microns. A mold platen operative in the present invention is formed of materials conventional to the art of thermoset resin cure and are known to illustratively include steel, brass, copper, and aluminum.

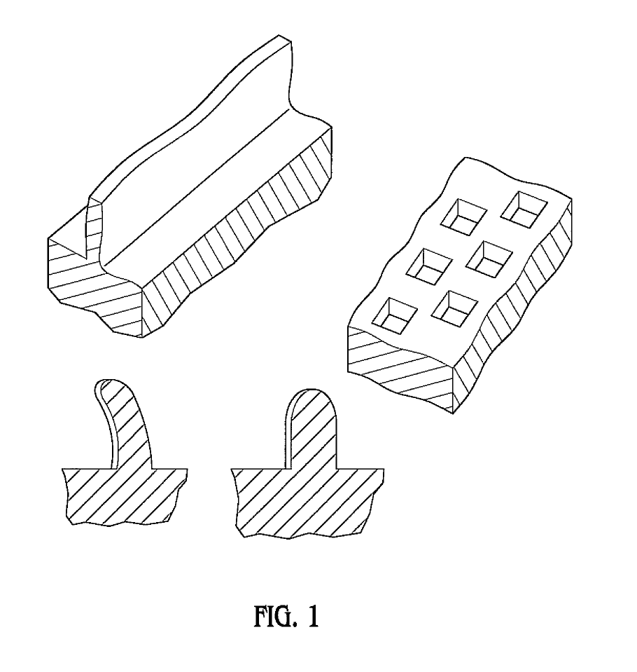

A contour applied to a mold platen is patterned in a variety of forms. U.S. Pat. No. 3,911,187 is representative of a stepped contour simulative of cloth. Alternate contours correspond to patterns of protuberances formed as flagella or ridges that bend under tactile pressure so as to simulate a fabric weave when interspersed with depressions. The depth differential between protuberances and depressions is between 35 and 1000 microns and preferably between 35 and 400 microns. Optionally, the protuberances and depressions are regularly interspersed. It is appreciated that a more ordered array and a higher density of crevices in a mold platen yields a sunshade panel surface simulative of a finer weave cloth. Tile sensation of a soft cloth is enhanced by a protrusion having a blunt end that is easily bent. Representative panel surface forms simulative of cloth are depicted in FIG. 1.

In operation, a fiber reinforcement sheet is dimensioned to fit within the mold cavity and is contacted with curable resin. The fiber reinforcement sheet illustratively includes S-glass, E-glass, woven carbon fiber, and woven polyamide fiber. With the inclusion of a curable resin, the mold cavity is closed and temperature and pressure are applied to induce resin cure. Optionally, a plasticizer is introduced into the curable resin formulation to provide the cloth simulative surface with a comparatively softer tactile feel. A plasticizer operative herein illustratively includes Diethylene Glycol E (The Dow Chemical Co.) and high molecular weight benzyl phthalate (Santicizer® 278, Ferro Corp.). A plasticizer is typically added in an amount from 0 to 4 total weight percent of the resin formulation and preferably between 0.1 and 2 total weight percent. The pressure associated with thermoset cure causes the curable resin to encompass the fiber reinforcement sheet as well as to penetrate the crevices of the contoured mold platen. It is appreciated that a lower initial viscosity curable resin facilitates contoured mold platen crevice penetration by the resin.

Upon resin cure within the mold cavity, the mold is opened and the formed vehicle roof panel is removed. It is appreciated that the application of a mold release compound to the contoured mold platen facilitates panel removal. The resulting panel has a visual and tactile finish simulative of a cloth layer. The panel is prepared for installation through resort to conventional finishing steps illustratively including trimming, and edge sanding.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A vehicle body component comprising:
a fiber reinforced cured material panel having an interior facing surface relative to a vehicle passenger compartment, the interior surface having a texture simulative of cloth absent the application of a cloth layer to the interior facing surface.

2. The component of claim 1 wherein the interior facing surface has a plurality of protuberances extending from the interior facing surface, said plurality of protuberances spaced apart, each of said protuberances having a height of between 35 and 1000 microns.

3. The component of claim 2 wherein said plurality of protuberances are regularly interspersed on said interior surface.

4. The component of claim 2 wherein said panel is a vehicle roof panel.

5. The component of claim 2 wherein said panel is a retractable sunshade panel.

6. The component of claim 1 wherein said panel is reinforced with a fiber reinforcement sheet selected from the group consisting of: S-glass, E-glass, woven carbon fiber, and woven polyamide fiber.

7. The component of claim 2 wherein said plurality of protuberances each have a blunt end extending from the interior facing surface.

8. The component of claim 1 having an exterior facing surface in opposition to the interior facing is smooth and lacks the texture simulative of cloth.

9. A method of forming a vehicle roof panel comprising:
laying a fiber reinforcement mat onto a first mold platen, said first mold platen having a cavity shaped for the outside of the panel;
pouring a predetermined quantity of thermoset curable resin over said fiber reinforcement mat in said first mold platen;
sealing said first mold platen with a second mold platen, said second mold platen having interspersed crevices defining dimensions and spacing of a plurality of protuberances for shaping an interior facing surface of said panel; and
applying heat and pressure for a sufficient amount of time for said thermoset curable resin to encapsulate said fiber reinforcement mat and to penetrate the crevices in said second mold platen to yield the panel with the interior facing surface having texture simulative of cloth.

10. The method according to claim 9, wherein said second mold platen is contoured through a technique selected from the group consisting of etching, machining and embossing.

11. The method according to claim 9, wherein said contoured second mold platen is roughened to have a mean depth differential between plateau and crevice features of between 35 and 1000 microns.

12. The method according to claim 9, further comprising introducing a plasticizer to said curable resin formulation in an amount up to 4 total weight percent of said curable resin formulation.

13. The method according to claim 12, wherein the said plasticizer is added in all amount between 0.1 and 2 total weight percent of said curable resin formulation.

14. The method of claim 9 wherein the surface texture simulative of cloth is applied in a vehicle independent of applying a fabric layer to the surface.
